(19) United States
(12) Patent Application Publication
(10) Pub. No.: US 2009/0084346 A1
(43) Pub. Date: Apr. 2, 2009

(54) GAS FLOW INJECTOR AND METHOD OF INJECTING GAS INTO A COMBUSTION SYSTEM

(75) Inventors: Wei Zhou, Foothill Ranch, CA (US); David K. Moyeda, Laguna Hills, CA (US); William T. Lipinski, Canton, OH (US); Quang H. Nguyen, Aliso Viejo, CA (US); Larry W. Swanson, Laguna Hills, CA (US)

Correspondence Address: GE ENERGY GENERAL ELECTRIC;C/O ERNEST G. CUSICK, ONE RIVER ROAD, BLD. 43, ROOM 225, SCHENECTADY, NY, 12345, US

(73) Assignee: General Electric Company

(21) Appl. No.: 11/863,960

(22) Filed: Sep. 28, 2007

(51) Int. Cl. F02F 3/26

(52) U.S. Cl. 123/276; 123/305

(57) ABSTRACT

An improved gas flow injector has been developed for use in a combustion system. The gas flow injector has an inner nozzle with tubular configuration for directing a first gas stream to a location distal to the gas flow injector. The inner nozzle has an outlet end portion and a longitudinal central axis. Disposed about the inner nozzle is an outer nozzle having a tubular configuration, for directing a second gas stream to a location proximal to the gas flow injector. A diverter is mounted to the outlet end portion of the inner nozzle and extends at least partially into the second gas stream. The diverter has a surface disposed at an acute angle relative to the longitudinal central axis of the inner nozzle to redirect at least a portion of the second gas stream in a direction transverse to the longitudinal central axis. Also disclosed is a method of injecting a gas into a combustion system using the gas flow injector of this invention.

### BACKGROUND OF THE INVENTION

This invention relates generally to gas flow injectors for combustion systems and, particularly, to injectors for secondary air in fossil fuel fired boilers.

Combustion systems are used in numerous industrial environments to generate heat and hot gases. For example, boilers and furnaces burn hydrocarbon fuels, e.g., oil and coal, in stationary combustors to produce heat to raise the temperature of a fluid, e.g., water. Industrial combustors typically employ various burner elements to combust the fuel and air injectors to provide combustion air to ensure complete combustion of the fuel. A typical industrial furnace, whether gas or fossil fired and hereafter referred to as a boiler, typically includes a lower combustion zone and a generally vertically extending flue gas passage.

The air introduced into a combustion system may be staged, i.e. introduced to the system in multiple stages to optimize combustion. In staging, primary air is mixed with the fuel as both are injected into a combustion zone. Secondary air (air without fuel) is injected in the primary combustion zone, and also may be injected into a combustion chamber downstream (in the direction of flue gas flow) of the primary combustion zone, as with overfire air (OFA). The secondary air may be used to burnout any unburned hydrocarbons remaining from the primary combustion zone.

Overfire air is typically injected into the flue gas at a location in the flue gas passage downstream of the combustion zone. Overfire air staging reduces the flow of combustion air provided to the combustion zone, suppressing NOx formation. The reduced oxygen in the combustion zone increases the level of unburned hydrocarbons in the flue gas. The overfire air, introduced above the primary combustion zone, completes combustion of the unburned hydrocarbons, which are then converted to carbon dioxide and water.

Gas flow injectors, such as those used to inject overfire air into boilers, are designed to provide mixing of the injected gas with the primary stream. Since boilers are relatively large in size, it can be difficult to inject a gas in such a way as to obtain penetration and mixing in the areas distant from the injection location (hereafter referred to as far-field) as well as in the areas adjacent to, or near, the injection location (hereafter referred to as near-field). One approach to achieve this goal has been the use of double concentric tube gas flow injectors with swirlers. In these injectors, far-field penetration and mixing is achieved by directing gas at high velocity through the inner annulus. Near-field mixing is provided by lower velocity gas injected through the outer annulus, which may flow through swirlers.

Swirlers are typically angled vanes that are disposed peripherally around the inner tube, within the outer annulus. They are designed to impart a tangential component to the velocity of the gas flow, causing a swirling motion of the gas flowing through the outer annulus. Upon discharge into the combustion system the gas expands outward and mixes with the primary flow in the near field. The location of the swirlers in the longitudinal direction of the injector varies to some degree, but they are generally located toward the upstream end of the injector and are not positioned at the outlet end of the injector. Though effective in providing near-field mixing, swirlers are very heavy and expensive, and provide restricted design flexibility. Thus there is a need for a gas flow injector that provides good near and far field mixing, design flexibility, and reduced cost and weight compared to conventional injectors that employ swirling elements.

### SUMMARY OF THE INVENTION

According to one aspect of the invention, an improved gas flow injector has been developed for use in a combustion system. The gas flow injector has an inner tubular nozzle for directing a first gas stream to a location distal to the gas flow injector. The inner nozzle has an outlet end portion and a longitudinal central axis. Disposed about the inner nozzle is a tubular outer nozzle for directing a second gas stream to a location proximal to the gas flow injector. A diverter is mounted to the outlet end portion of the inner nozzle and extends at least partially into the second gas stream. The diverter has a surface disposed at an acute angle relative to the longitudinal central axis of the inner nozzle to redirect at least a portion of the second gas stream in a direction transverse to the longitudinal central axis.

According to another aspect of the invention, a method has been developed to inject gas into a combustion system through a gas flow injector. The method includes the step of directing a first stream of gas through a tubular inner nozzle to a location in the combustion system distal to the gas flow injector. The inner nozzle has an outlet end portion and a longitudinal central axis. A second stream of gas is directed through an outer tubular nozzle to a location in the combustion system proximal to the gas flow injector. The outer tubular nozzle is disposed about the inner nozzle. At least a portion of the second stream of gas is redirected in a direction transverse to the longitudinal central axis of the inner nozzle. A diverter is mounted to the outlet end portion of the inner nozzle and extends at least partially into the second gas stream. The diverter has a surface disposed at an acute angle relative to the longitudinal central axis of the inner nozzle.

### BRIEF DESCRIPTION OF THE DRAWINGS

These and other features, aspects, and advantages of the invention will be better understood when the following detailed description is read with reference to the accompanying drawing, in which:

FIG. 1 is a schematic diagram showing a side, cross-sectional view of a combustion system;

FIG. 2 is a perspective view of a gas flow injector of the present invention; and

FIG. 3 is a side view, shown in partial cross-section, of the gas flow injector shown in FIG. 2.

### DETAILED DESCRIPTION OF THE INVENTION

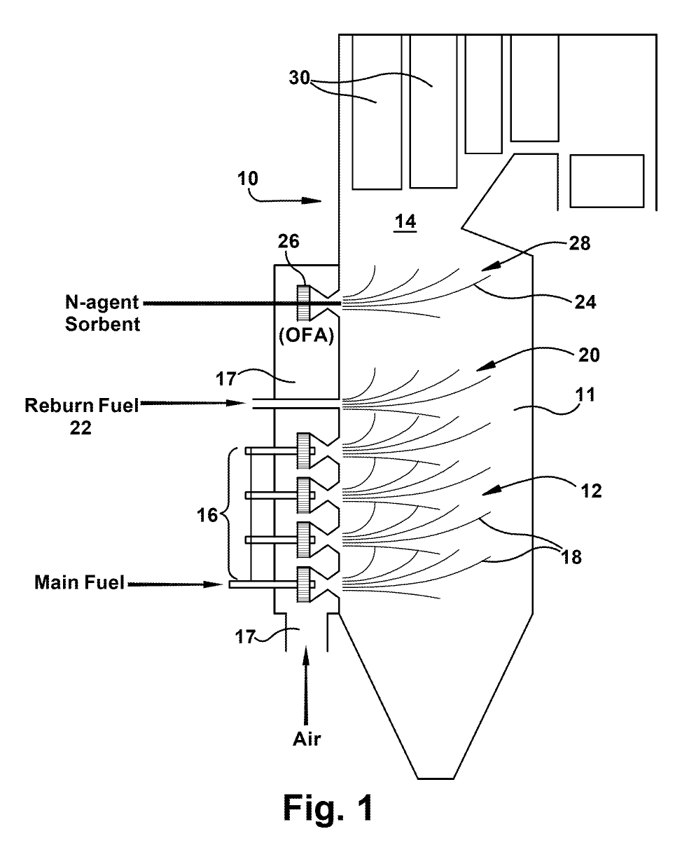

FIG. 1 is schematic diagram of a combustion system 10, e.g., a boiler, with a sidewall removed to show the interior combustion zone 12 and flue gas duct 14. The combustion system 10 may be a large hollow structure 11 that is more than one, two or even three hundred feet tall. The combustion system 10 may include a plurality of combustion devices 16, e.g., an assembly of combustion fuel nozzles and air injectors, which mix fuel and air to generate flame in the combustion zone 12. The combustion device 16 may include burners, e.g., gas-fired burners, coal-fired burners and oil-fired burners. The burners may be arranged on one or more walls, e.g., front and back walls, of the structure 11 of the combustion system 10.

The burners may be situated in a wall-fired, opposite-fired, tangential-fired, or cyclone arrangement, and may be arranged to generate a plurality of distinct flames, a common fireball, or any combination thereof. Air for the burners may flow through an air duct(s) 17 on an outside wall(s) of the structure 11.

The fuel/air mixture 18 injected by the combustion devices 16 burns primarily in the combustion zone 12 and generates hot combustion gases that flow upward through the flue gas passage 14. From the combustion zone 12, the hot combustion gases flow into an optional reburn zone 20 into which additional (reburn) fuel 22 is supplied to the hot combustion gases to promote additional combustion.

Downstream of combustion and reburn zones, overfire air (OFA) 24 is injected through an overfire air injector(s) 26 into the OFA burnout zone 28 in the flue gas stream. A reducing agent, e.g., nitrogen (N-agent), and/or sorbent, may be injected into the flue gases with one or more of the streams of overfire air. Downstream of the OFA burnout zone, the combustion flue gas passes through a series of heat exchangers 30 and a particulate control device (not shown), such as an electrostatic precipitator (ESP) or baghouse, which removes solid particles from the flue gas, such as fly ash.

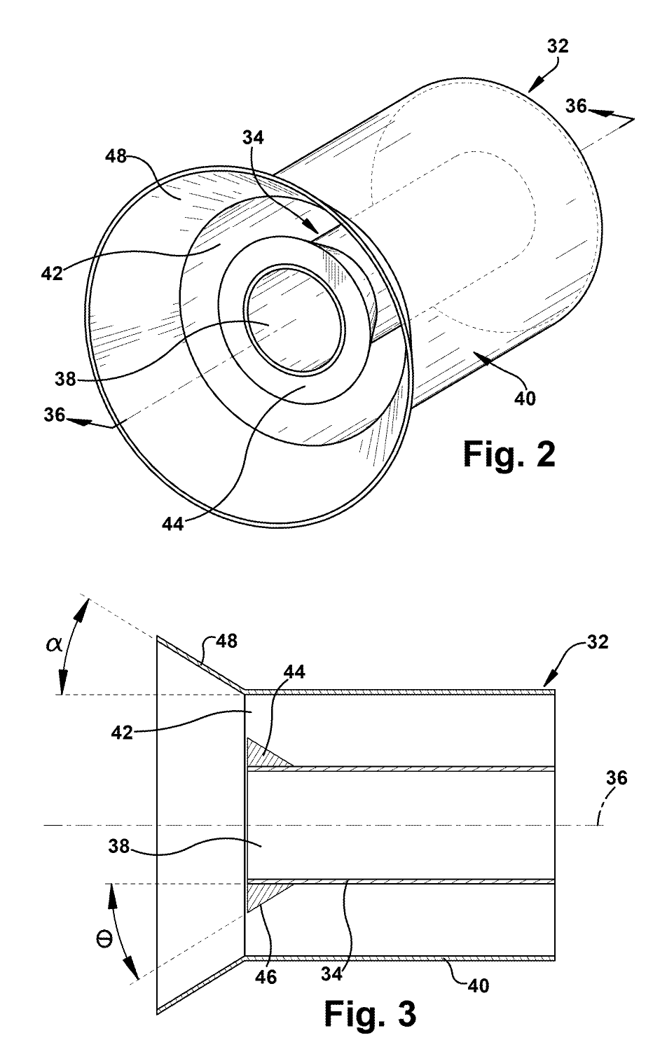

FIG. 2 is a perspective view and FIG. 3 is a side view, shown in partial cross-section, of an embodiment of the inventive gas flow injector 32. The gas flow injector 32 has an inner nozzle 34, which has a tubular configuration with a longitudinal central axis 36 and an outlet end portion 38. The inner nozzle 34 directs a first stream of gas to a location distal to the gas flow injector 32, effecting far-field mixing of the gas with the primary flow of the combustion gases in the combustion system 10. It should be noted that as used herein the term “tubular” refers to any annulus with a longitudinal central axis through which fluid may flow. The cross-section of the tubular members of this invention may be any shape including circular, oval, elliptical, square, or rectangular, as suitable for the specific combustion system. In one embodiment the tubular configuration of the inner nozzle is cylindrical such that its cross-section is circular.

The gas flow injector 32 includes an outer nozzle 40 disposed about the inner nozzle 34. The outer nozzle 40 directs a second stream of gas to a location proximal to the gas flow injector 32, effecting near-field mixing of the gas with the primary flow of the combustion gases in the combustion system 10. The outer nozzle 40 has a tubular configuration with an outlet end portion 42. In one embodiment the tubular configuration of the outer nozzle 40 is cylindrical such that its cross-section is circular.

The gas flow injector 32 further includes a diverter 44 mounted to the outlet end portion 38 of the inner nozzle 34. The diverter 44 extends at least partially into the second gas stream and has a surface 46 disposed at an acute angle (θ) relative to the longitudinal central axis 36 of the inner nozzle 34. Upstream of the diverter 44, the velocity of the second gas stream is predominantly axial in direction. The diverter redirects at least a portion of the second stream of gas flowing through the outer nozzle 40 in a direction transverse to the longitudinal central axis. This directs the second gas stream to a location proximal to the gas flow injector 32. In one embodiment the inner and outer nozzle have a cylindrical configuration and the second gas stream is redirected in a radial direction relative to the longitudinal central axis. The exact acute angle θ selected will determine the degree to which the gas stream is redirected. This angle may be varied and selected by the practitioner to meet the needs of a specific combustion system. In one embodiment the angle, θ, is between 10 and 60 degrees. In another embodiment the angle, θ, is between 20 and 45 degrees.

The outer nozzle 40 of the gas flow injector is connected to the combustion system 10 through a throat 48. The surface of the throat 48 is disposed at an angle (α) relative to the longitudinal central axis 36 of the inner nozzle 34. This angle may be varied and selected by the practitioner to meet the needs of a specific combustion system. In one embodiment the angle, α, is between 10 and 60 degrees. In another embodiment the angle, α, is between 20 and 45 degrees.

The angle of the throat 48 surface (α) and the angle of the surface of the diverter 46 (θ) may be the same, or they may be different. In one embodiment α and θ are equal, such that the surface of the throat 48 and the surface of the diverter 46 are parallel.

The gas flow injector 32 may be housed within a variety of gas injector assemblies, as required for a particular injector use. In one embodiment the gas flow injector 32 is utilized in the overfire air injector(s) 26 shown in FIG. 1. The overfire air may be cooled, at ambient temperature, or at an elevated temperature. Elevated temperatures vary depending on the specific combustion system, but typically range from 130° to 700° F. Additionally, the overfire air may be injected at low pressure as with standard overfire air, or relatively higher pressure as with boosted overfire air (BOFA). Typically, standard overfire air is injected at pressures ranging from 4 to 12 inches H₂O whereas BOFA is injected at pressures ranging from 20 to 40 inches H₂O.

The first and second gas streams will typically have the same composition, temperature, pressure, and source. However, if desired, the two streams of gas may be different from one another in any of these respects.

In one embodiment, a selective reducing agent (N-agent) is added to the overfire air prior to or concurrently with injection of the gas into the combustion system 10. As used herein, the terms “selective reducing agent” and “N-agent” are used interchangeably to refer to any of a variety of nitrogenous chemical species capable of selectively reducing NOₓ in the presence of oxygen in a combustion system. In general, suitable selective reducing agents include urea, ammonia, cyanuric acid, hydrazine, thanolamine, biuret, triuret, ammelide, ammonium salts of organic acids, ammonium salts of inorganic acids, and the like. Specific examples of ammonium salt reducing agents include ammonium sulfate, ammonium bisulfate, ammonium bisulfite, ammonium formate, ammonium carbonate, ammonium bicarbonate, ammonium nitrate, and the like. Mixtures of these selective reducing agents can also be used. The selective reducing agent is provided in a solution, preferably an aqueous solution, or in the form of a powder or a gas. In one embodiment the selective reducing agent is selected from the group consisting of gaseous ammonia, aqueous ammonia, and urea in aqueous solution.

In another embodiment a sorbent is added to the gas prior to or concurrently with injection of the gas into the combustion system. The sorbent may be effective for any pollutant. In one embodiment the sorbent is effective to treat for mercury, SO₂, SO₃, SO₄, HCl, or a combination of these. Examples of suitable sorbents include hydrated lime, limestone, dolomite, trona, promoted hydrated lime, clay sorbents, kaolin, kaolinite, and zeolite sorbents.

There is a long felt need for a gas flow nozzle that provides good near field mixing while maintaining far field penetration, which is light, inexpensive, and offers design flexibility. The gas flow nozzle of this invention, which includes the diverter element, is much lighter and less expensive to manufacture compared to prior art nozzles that utilize swirlers to induce near-field mixing. Furthermore, the diverter is comparatively easy to replace, offering design flexibility throughout the life of the nozzle.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A gas flow injector for use in a combustion system, the gas flow injector comprising:
an inner nozzle having a tubular configuration with a longitudinal central axis and an outlet end portion, the inner nozzle for directing a first gas stream to a location distal to the gas flow injector;
an outer nozzle disposed about the inner nozzle for directing a second cas stream to a location proximal to the gas flow injector, the outer nozzle having a tubular configuration; and
a diverter mounted to the outlet end portion of the inner nozzle to extend at least partially into the second gas stream, the diverter having a surface disposed at an acute angle relative to the longitudinal central axis of the inner nozzle to redirect at least a portion of the second gas stream in a direction transverse to the longitudinal central axis.

2. The gas flow injector of claim 1 wherein the inner and outer nozzle have a cylindrical configuration and the second gas stream is redirected in a radial direction relative to the longitudinal central axis.

3. The gas flow injector of claim 1 wherein the acute angle is between 10 and 60 degrees.

4. The gas flow injector of claim 1 wherein the acute angle is between 20 and 45 degrees.

5. The gas flow injector of claim 1 further comprising a throat that has a surface disposed at an acute angle relative to the longitudinal central axis of the inner nozzle.

6. The gas flow injector of claim 5 wherein the angle of the throat surface and the angle of the surface of the diverter are equal.

7. A method of injecting gas into a combustion system through a gas flow injector, the method comprising the steps of:
directing a first gas stream through an inner nozzle to a location in the combustion system distal to the gas flow injector, the inner nozzle having a tubular configuration with a longitudinal central axis and an outlet end portion;
directing a second gas stream through an outer nozzle to a location in the combustion system proximal to the gas flow injector, the outer nozzle disposed about the inner nozzle and having a tubular configuration; and
redirecting at least a portion of the second gas stream in a direction transverse to the longitudinal central axis of the inner nozzle with a diverter mounted to the outlet end portion of the inner nozzle and extending at least partially into the second gas stream, the diverter having a surface disposed at an acute angle relative to the longitudinal central axis of the inner nozzle.

8. The method of claim 7 wherein the inner and outer nozzle have a cylindrical configuration and the second gas stream is redirected in a radial direction relative to the longitudinal central axis.

9. The method of claim 7 wherein the acute angle is between 10 and 60 degrees.

10. The method of claim 7 wherein the acute angle is between 20 and 45 degrees.

11. The method of claim 7 wherein the gas is air.

12. The method of claim 7 wherein the gas is overfire air.

13. The method of claim 7 wherein the gas is boosted overfire air.

14. The method of claim 11 wherein the air is at ambient temperature.

15. The method of claim 11 wherein the air is at an elevated temperature.

16. The method of claim 11 wherein the air is between 130° and 700° F.

17. The method of claim 7 wherein a selective reducing agent is injected with the gas.

18. The method of claim 17 wherein the selective reducing agent is selected from the group consisting of gaseous ammonia, aqueous ammonia and urea in aqueous solution.

19. The method of claim 7 wherein a sorbent to treat for pollutants is injected with the gas.

20. The method of claim 19 wherein the sorbent is effective to treat for pollutants selected from the group consisting of mercury, SO₂, SO₃, SO₄, and HCl.

21. The method of claim 19 wherein the sorbent is selected from the group consisting of hydrated lime, limestone, dolomite, trona, promoted hydrated lime, clay sorbents, kaolin, kaolinite, and zeolite sorbents.
